(19) United States
(12) Patent Application Publication
(10) Pub. No.: US 2025/0385540 A1
(43) Pub. Date: Dec. 18, 2025

(54) MODULAR POWER SUPPLIES

(71) Applicant: TECHTRONIC CORDLESS GP, Anderson, SC (US)

(72) Inventors: Devin Whitmore, Anderson, SC (US); John Earl, Townville, SC (US); Jonathan Feldkamp, Anderson, SC (US); Raony Barrios, Anderson, SC (US); Richard Simpson, Greenville, SC (US); Mark Hannah, Anderson, SC (US); Elry Hodge, Sugar Hill, GA (US); Clint Cagle, Easley, SC (US); Reid Stayanoff, Anderson, SC (US); Brian George, Spartanburg, SC (US); Sean Campbell, Anderson, SC (US); Shane Glasgow, Anderson, SC (US); Berkley Wilcox, Anderson, SC (US)

(21) Appl. No.: 19/242,299

(22) Filed: Jun. 18, 2025

Related U.S. Application Data
(60) Provisional application No. 63/661,254, filed on Jun. 18, 2024.

(51) Int. Cl. H02J 7/34; H02J 1/06; H02J 3/32; H02J 7/00

(52) U.S. Cl. CPC H02J 7/342; H02J 1/06; H02J 3/32; H02J 7/0016; H02J 7/0018; H02J 7/007182; H02J 2207/20; H02J 2300/24

(57) ABSTRACT

Modular power supplies and configurations of connecting the same. One example provides a power supply system comprising a battery extender configured to output first direct current (DC) power and a power station electrically connected to the battery extender. The power station includes a battery, a DC input port configured to receive the first DC power from the battery extender and an alternating current (AC) port configured to receive first AC power from an external power supply. The power station also includes a DC output port configured to provide second DC power to a first connected device, and an AC output port configured to provide second AC power to a second connected device.

### CROSS-REFERENCE TO RELATED APPLICATIONS

This application claims the benefit of U.S. Provisional Patent Application No. 63/661,254, filed Jun. 18, 2024, the entire content of which is hereby incorporated by reference.

### FIELD OF TECHNOLOGY

The present technology generally relates to modular power supplies and configurations of connecting the same.

### SUMMARY

Embodiments described herein provide for various power supplies, including power stations, battery extenders, and battery packs. Power stations and battery extenders described herein may include one or more internal batteries or may include an interface configured to receive one or more external battery packs. Power stations may also be configured to receive power from an alternating current source. Power stations are configured to output both alternating current power and direct current power. Battery extenders are configured to output direct current power.

One embodiment provides a power supply system comprising a battery extender configured to output a first direct current (DC) power and a power station electrically connected to the battery extender. The power station includes a battery, a DC input port configured to receive the first DC power from the battery extender and an alternating current (AC) input port configured to receive first AC power from an external power supply. The power station also includes a DC output port configured to provide second DC power to a first connected device, and an AC output port configured to provide second AC power to a second connected device.

Another embodiment provides a power station comprising a plurality of batteries, a DC input port configured to receive a DC power from an external battery extender, and an AC input port configured to receive a first AC power from an external power supply. The power station includes a DC output port configured to provide a second DC power to a first connected device and an AC output port configured to provide a second AC power to a second connected device. The power station includes a battery management system configured to charge the plurality of batteries in response to receiving power from at least one selected from a group consisting of the DC input port and the AC input port.

Other aspects of the technology may become apparent by consideration of the detailed description, claims, and accompanying drawings.

### BRIEF DESCRIPTION OF THE DRAWINGS

FIG. 1 illustrates a perspective view of a power station in accordance with some examples.

FIG. 2 illustrates a block diagram of the power station of FIG. 1 in accordance with some examples.

FIG. 3 illustrates a perspective view of another power station in accordance with some examples.

FIG. 4 illustrates a perspective view of a plurality of stacked power stations in accordance with some examples.

FIG. 5 illustrates a circuit diagram of the power station of FIG. 1 or FIG. 3 in accordance with some examples.

FIG. 6 illustrates a perspective view of an inverter module in accordance with some examples.

FIGS. 7A-7B illustrate perspective views of an MPPT module in accordance with some examples.

FIG. 8 illustrates a perspective view of a DC output module in accordance with some examples.

FIG. 9 illustrates a perspective view of a battery module in accordance with some examples.

FIG. 10A illustrates a perspective view of a combined USB and display module in accordance with some examples.

FIG. 10B illustrates a circuit diagram of the combined USB and display module of FIG. 10A in accordance with some examples.

FIG. 11 illustrates another circuit diagram of the power station of FIG. 1 or FIG. 3 in accordance with some examples.

FIG. 12 illustrates another circuit diagram of the power station of FIG. 1 or FIG. 3 in accordance with some examples.

FIG. 13 illustrates a perspective view of a charger module in accordance with some examples.

FIG. 14 illustrates another circuit diagram of the power station of FIG. 1 or FIG. 3 in accordance with some examples.

FIG. 15 illustrates a perspective view of a 3.6K inverter module in accordance with some examples.

FIG. 16 illustrates a power station connected in series with a plurality of extension batteries in accordance with some examples.

FIG. 17 illustrates a circuit diagram of an example extension battery in accordance with some examples.

FIG. 18 illustrates a circuit diagram of an example power station in accordance with some examples.

FIG. 19 illustrates a circuit diagram of an example battery management system in accordance with some examples.

FIG. 20 illustrates a power supply system including two power stations in accordance with some examples.

FIG. 21 illustrates another power supply system including two power stations in accordance with some examples.

FIG. 22 illustrates another power supply system including two power stations in accordance with some examples.

FIG. 23 illustrates a perspective view of a battery extender in accordance with some examples.

FIG. 24 illustrates a power supply system including a power station and a battery extender in accordance with some examples.

FIG. 25 illustrates another power supply system including a power station and a battery extender in accordance with some examples.

FIG. 26 illustrates another power supply system including a power station and a battery extender in accordance with some examples.

### DETAILED DESCRIPTION

Before any implementations of the disclosure are explained in detail, it is to be understood that the disclosure is not limited in its application to the details of construction and the arrangement of components set forth in the following description or illustrated in the following drawings. The disclosure is capable of other implementations and of being practiced or of being carried out in various ways.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using other known means including direct connections, wireless connections, etc.

Relative terminology, such as, for example, “about”, “approximately”, “substantially”, etc., used in connection with a quantity or condition would be understood by those of ordinary skill to be inclusive of the stated value or condition and has the meaning dictated by the context (for example, the term includes at least the degree of error associated with the measurement of, tolerances (e.g., manufacturing, assembly, use, etc.) associated with the particular value or condition, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some examples, embodiments, aspects, and features described herein may include one or more electronic processors configured to perform the described functionality by executing instructions stored in non-transitory, computer-readable medium. Similarly, examples and embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

It should also be noted that a plurality of hardware and software based devices, as well as a plurality of different structural components, may be utilized to implement the disclosure. Furthermore, and as described in subsequent paragraphs, the specific configurations illustrated in the drawings are intended to exemplify implementations of the disclosure. Alternative configurations are possible.

Examples, aspects, and implementations described herein relate to power supplies, including power stations, battery extenders, battery packs, and the like. As referred to herein, a power station (e.g., an inverter) is a power supply capable of outputting both AC power and DC power. A battery extender is a power supply capable of only outputting DC power from internal batteries or connected battery packs.

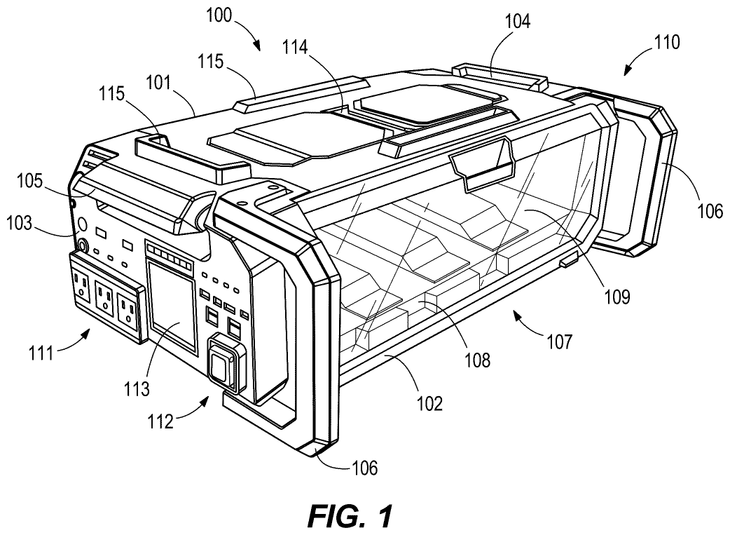

FIG. 1 illustrates a power station 100 in accordance with some examples. The power station 100 includes a housing comprised of an upper housing portion 101, a lower housing portion 102, a first side portion 103, and a second side portion 104. The upper housing portion 101, the lower housing portion 102, the first side portion 103 and the second side portion 104 are each connected by a back wall (not shown). The housing may also include one or more handles for lifting the power station 100, such as a horizontal handle 105 and vertical handles 106.

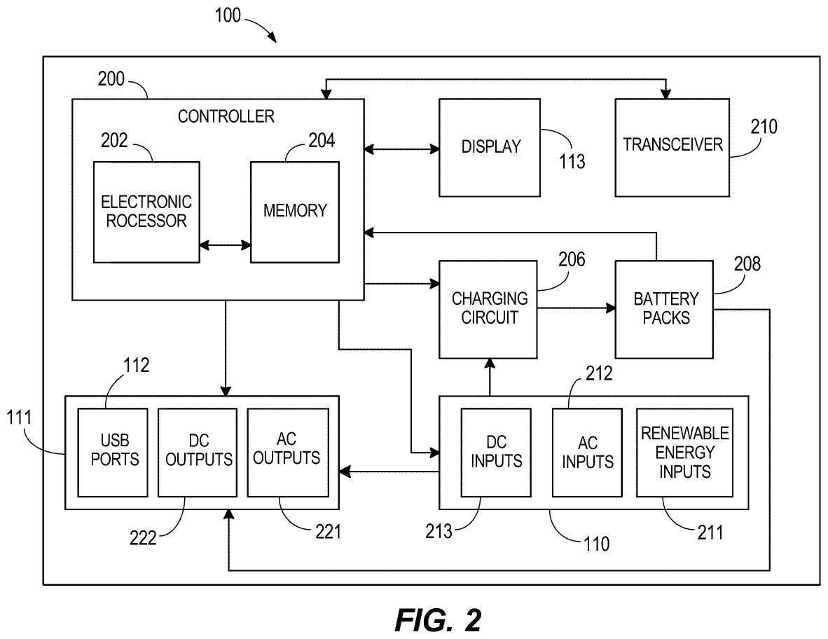

The housing may include a recess 107 configured to receive one or more battery packs 208 (shown in FIG. 2). For example, the lower housing portion 102 includes a battery pack interface 108 (e.g., a terminal assembly) configured to receive battery packs such that the battery packs are electrically and mechanically coupled to the power station 100. The battery pack interface 108 may include a positive power terminal and a negative power terminal. In some examples, the battery pack interface 108 may also include a separate charging terminal and/or one or more communication/data terminals. Battery packs received by the battery pack interface 108 are supported by the lower housing portion 102. The recess 107 may be enclosed by a cover 109. The cover 109 may be coupled to the upper housing portion 101 by a hinge such that the cover 109 may be opened or closed via rotation about a hinge. The cover 109 may be composed of a transparent material (for example, plexiglass or translucent plastic) or an opaque material.

The power station 100 includes a plurality of power inputs 110. The plurality of power inputs 110 may be situated on the second side portion 104. The plurality of power inputs 110 include, for example, one or more renewable energy inputs 211 (e.g., one or more solar panel inputs, one or more turbine inputs, etc.), one or more alternating current (AC) inputs 212, one or more direct-current (DC) inputs 213 (e.g., a USB input, a USB-C input), and combinations thereof (see, for example, FIG. 2). In some implementations, the plurality of power inputs 110 include exactly one renewable energy input 211, one AC input 212, and one DC input 213. The input power provided by the renewable energy input 211 may range from, for example, approximately 500-1500 W, approximately 750-1250 W, approximately 1000 W, and the like. The input power provided by the AC input 212 may be approximately 210-220 W (for example, 216 W). The input power provided by the DC input 213 may be approximately 90-110 W (for example, 100 W). The power received by the power station 100 via the plurality of power inputs 110 may be used, for example, for charging batteries received by the battery pack interface 108.

The power station 100 also includes a plurality of power outputs 111. The plurality of power outputs 111 may be situated on the first side portion 103. The plurality of power outputs 111 include, for example, one or more AC outputs 221 and one or more DC outputs 222 (see, for example, FIG. 2). In some implementations, the plurality of power outputs 111 include exactly three AC outputs 221 and one DC output 222. The voltage output by the AC outputs 221 may be, for example, 120V. The current provided by the AC outputs 221 may be, for example, 20A. The voltage output by the DC outputs 222 may be, for example, approximately 12-15V (for example, 13.8V). The current provided by the DC outputs 222 may be, for example, 10 A. The DC outputs 222 may be, for example, Cigarette Lighter Adapter (CLA) ports, Anderson connectors, or the like. In some instances, the power station 100 also includes a plurality of USB output ports 112. The plurality of USB output ports 112 may include, for example, one or more USB-A output ports and one or more USB-C output ports. In some implementations, the plurality of USB output ports 112 include exactly four USB-A output ports and four USB-C output ports. The USB output ports 112 may output a voltage of, for example, 5V, 9V, 12V, 15V, or 20V and output a current upwards of, for example, 3 A or 5 A.

In some implementations, the power station 100 also includes a display 113 (for example, a liquid crystal display [LCD] screen). The display 113 may be situated on the first side portion 103. The display 113 may be configured to display information related to the battery packs received by the battery pack interface 108, the plurality of power inputs 110, the plurality of power outputs 111, and combinations thereof. For example, the display 113 may display a charging status of the battery packs 208, a capacity of the battery packs 208, an input power received by the plurality of power inputs 110, an output power provided by the plurality of power outputs 111, a session runtime (or shut-down) timer, a wireless connection indication, and the like. In some implementations, the power station 100 also includes an area light (not shown) configured to illuminate an environment around or near the power station 100.

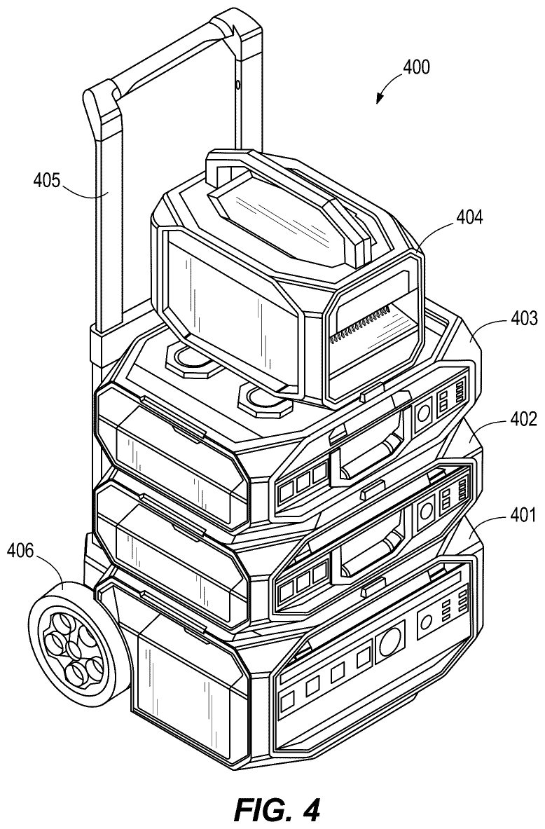

In some implementations, the power station 100 includes one or more wireless charging stations 114 configured to provide power wirelessly to devices near (e.g., situated approximate to) the one or more wireless charging stations 114. The one or more wireless charging stations 114 may be embedded within the upper housing portion 101. The one or more wireless charging stations 114 may be, for example, Qi-standard chargers compatible with charging mobile devices. In some examples, the upper housing portion 101 also includes one or more contours 115 configured to be received by one or more corresponding recesses of another power supply (for example, another power station or a battery extended). The power station 100 may include respective recesses (not shown) formed in the lower housing portion 102. In this manner, the power station 100 may be stacked on or beneath other power supplies (as shown in FIG. 4).

FIG. 2 illustrates a block diagram of the power station 100 in accordance with some examples. The power station 100 includes a controller 200, the plurality of power inputs 110, the plurality of power outputs 111, a charging circuit 206 connected to one or more battery packs 208, the display 113, and a transceiver 210. The controller 200 includes, among other things, an electronic processor 202 and a memory 204. The electronic processor 202 and the memory 204, as well as various modules connected to the controller 200, are connected by one or more control and/or data buses (for example, a common bus).

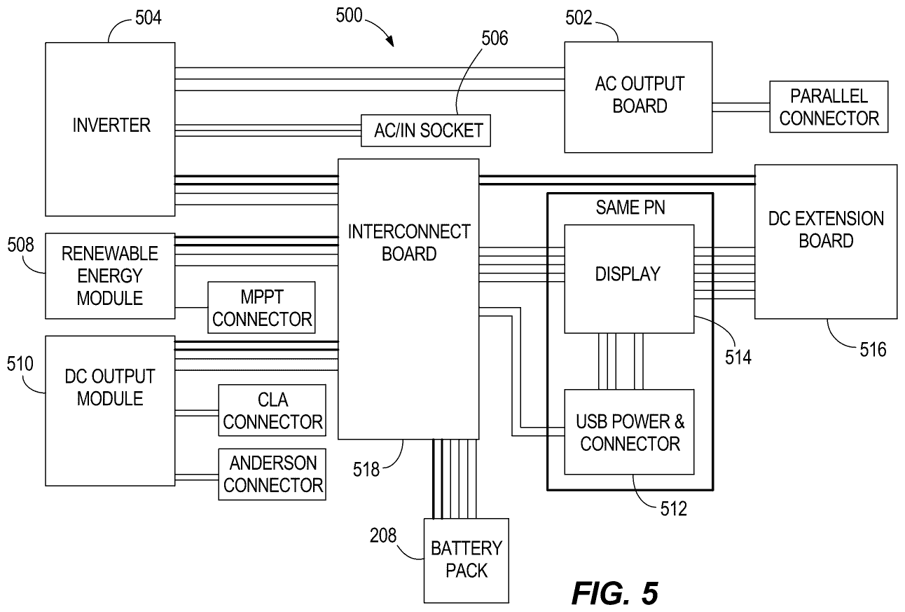

The memory 204 includes, for example, read-only memory (ROM), random access memory (RAM) (for example, dynamic RAM [DRAM], synchronous DRAM [DRAM], etc.), electronically erasable programmable read-only memory (EEPROM), flash memory, a hard disk, an SD card, other non-transitory computer-readable media, or a combination thereof. The electronic processor 202 is connected to the memory 204 and executes software instructions that are capable of being stored in a RAM of the memory 204 (for example, during execution), a ROM of the memory 204 (for example, on a generally permanent basis), or another non-transitory computer-readable medium such as another memory or a disc. Alternatively or in addition, the memory 204 is included in the electronic processor 202. Software included in some implementations of the power station 100 can be stored in the memory 204 of the controller 200. The software includes, for example, firmware, one or more applications, program data, filters, rules, one or more program modules, and other executable instructions. In other constructions, the controller 200 includes additional, fewer, or different components. For example, the controller 200 may be comprised of only hardware components, such as switches and logical gates. While FIG. 2 illustrates the controller 200 as a single component, operations performed by the controller 200 may alternatively be spread across multiple logical components or modules, such as described at least with respect to FIG. 5.

The controller 200 is connected (e.g., electrically and/or communicatively connected) to the plurality of power inputs 110 and may control the flow of power received by the plurality of power inputs 110. For example, the controller 200 may provide power from the plurality of power inputs 110 to the plurality of power outputs 111 as output power. In another example, the controller 200 may provide power from the plurality of power inputs 110 to the one or more battery packs 208 by controlling the charging circuit 206 to charge the battery packs 208. The battery packs 208 may be, for example, 40V battery packs. In the example of FIG. 2, the controller 200 is powered by the one or more battery packs 208. However, in other implementations, the controller 200 may instead or additionally receive power from another power source, such as the DC inputs 213 and/or the renewable energy inputs 211.

In some examples, the one or more battery packs 208 connected to the battery pack interface 108 are controlled (for example, by the controller 200) to provide power to the plurality of power outputs 111. This power may be separate from, or may supplement, the power provided to the plurality of power outputs 111 via the plurality of power inputs 110. One skilled in the art will appreciate that DC power provided by the one or more battery packs 208 and/or the plurality of power inputs 110 may be converted to AC power for output by the plurality of power outputs 111 using, for example, an inverter and/or converter.

The transceiver 210 enables the controller 200 to communicate with external devices. For example, the transceiver 210 may be operated by the controller 200 to send and receive wireless messages to an external device. In some instances, the transceiver employs Bluetooth® protocol for local wireless communication. However, other protocols may be implemented for the exchange of data, such as Wi-Fi, ZigBee, a proprietary protocol, and the like. The transceiver 210 may be configured to communicate via Wi-Fi through a wide area network such as the Internet or a local area network, or to communicate through a piconet (e.g., using infrared or NFC communications). In some examples, the transceiver 210 communicates over a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, 5G New Radio, a Digital Enhanced Cordless Telecommunications (“DECT”) network, a Digital AMPS (“IS-136/TDMA”) network, or an Integrated Digital Enhanced Network (“iDEN”) network, etc.

In some examples, a pass-through charging operation is implemented by the controller 200. For example, in some instances, a user of the power station 100 connects a device to one of the plurality of power outputs 111 or one of the plurality of USB output ports 112 while the power station 100 is also connected to a charging power source via at least one of the plurality of power inputs 110. In this instance, power is first passed to the respective one of the plurality of power outputs 111 or the respective one of the plurality of USB output ports 112 to provide power to the connected device. Any remaining input power from the plurality of power inputs 110 is used to charge the one or more battery packs 208 received by the battery pack interface 108.

In some instances, the power received at the plurality of power inputs 110 does not alone provide sufficient power to the connected device. In such an instance, at least one of the one or more battery packs 208 may be controlled to discharge and also provide power to the connected device. Accordingly, pass-through charging provides for the charging of connected devices using the plurality of power outputs 111 and/or the plurality of USB output ports 112 while also charging the one or more battery packs 208, should the power be available. When paired with the solar input, the power station 100 may also serve as a solar generator.

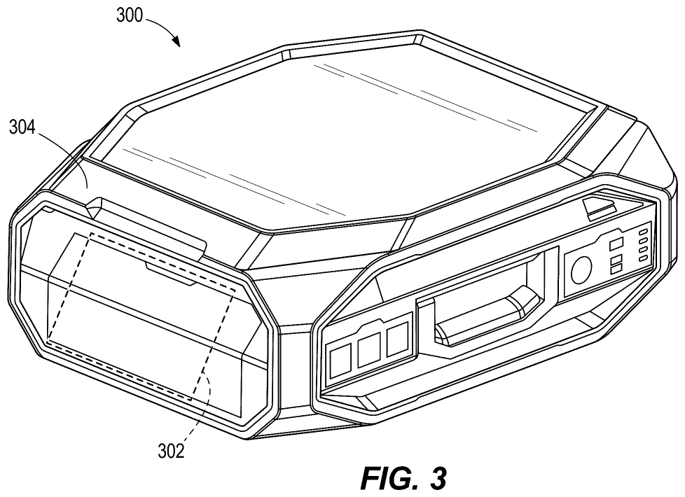

In some instances, rather than receiving battery packs, a power station may include one or more internal, non-removable batteries. FIG. 3 illustrates a power station 300 in accordance with further examples. The power station 300 includes internal batteries 302 within a housing 304. The internal batteries 302 may be, for example, 40 V batteries, 52.5 V, 80 V batteries, or the like. In some instances, the internal batteries 302 are lithium iron phosphate batteries. The internal batteries 302 may also be charged via the charging circuit 206 using power from the plurality of inputs 110. The power station 300, similar to the power station 100, may include one or more contours that are receivable by one or more recesses of another power supply.

As previously stated, the power station 100 and/or the power station 300 may be stacked on other power supplies. FIG. 4 illustrates a power supply system 400 including a plurality of stacked power supplies in accordance with some examples. In the illustrative example of FIG. 4, the power supply system 400 includes a first power station 401, a second power station 402 stacked on the first power station 401, a third power station 403 stacked on the second power station 402, and a fourth power station 404 stacked on the third power station 403. The contours of each power station 401, 402, 403, 404 align with respective recesses in the power station 401, 402, 403, 404 situated above to mechanically connect one power station to another. Each of the power stations 401, 402, 403, 404 may be, for example, the power station 100 or the power station 300. In some instances, the first power station 401 further includes a handle 405 and wheels 406 such that the power supply system 400 is capable of being moved. While not illustrated in FIG. 4, in some implementations a battery extender may also be stacked with a power station 100, 300.

The power station 100, 300 are composed of a plurality of various electrical modules. FIG. 5 illustrates an example circuit diagram 500 of the power station 100, 300 including various modules. The circuit diagram 500 is representative of circuitry within the power station 100, 300. The circuit diagram 500 includes, among other things, an AC output module 502, an inverter module 504, an AC input 506, a renewable energy module 508, a DC output module 510, a USB module 512, a display module 514, a DC extension module 516, and an interconnect module 518. Each of the modules may represent circuitry situated on a single printed circuit board (PCB) such that each module is physically independent from other modules. Additionally, each module may include its own controller (e.g., microcontroller, microprocessor) that controls operation of the respective module. In some instances, the display module 514 includes a primary controller that coordinates communication between each modules and provides instructions to each module.

The AC output module 502 is connected to the AC input 506 (of the plurality of power inputs 110) via the inverter module 504. The AC output module 502 includes the AC outputs 221 (of the plurality of power outputs 111) and provides power from the inverter module 504 to the AC outputs 221. The AC outputs 221 may include the one or more wireless charging stations 114.

The inverter module 504 may receive power from the AC input 506 or may receive power from a DC input (through the interconnect module 518). The inverter module 504 may provide the power to the AC output module 502. Additionally, the inverter module 504 may convert some or all of the power from the AC input 506 for DC power for use by other modules. In some examples, power from the inverter module 504 is provided to a desired module through the interconnect module 518. In some examples, the inverter module 504 receives DC power from the interconnect module 518, which is then converted by the inverter module 504 to AC power.

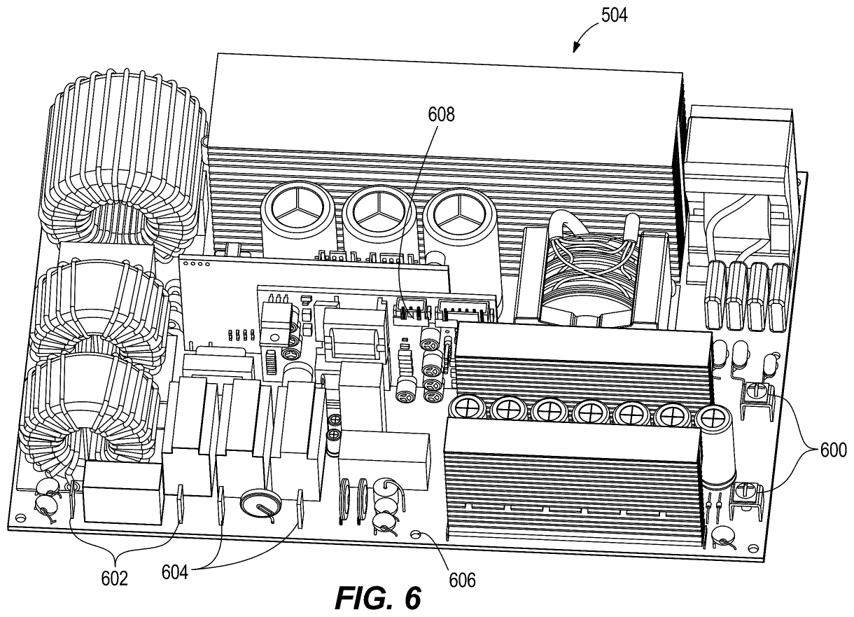

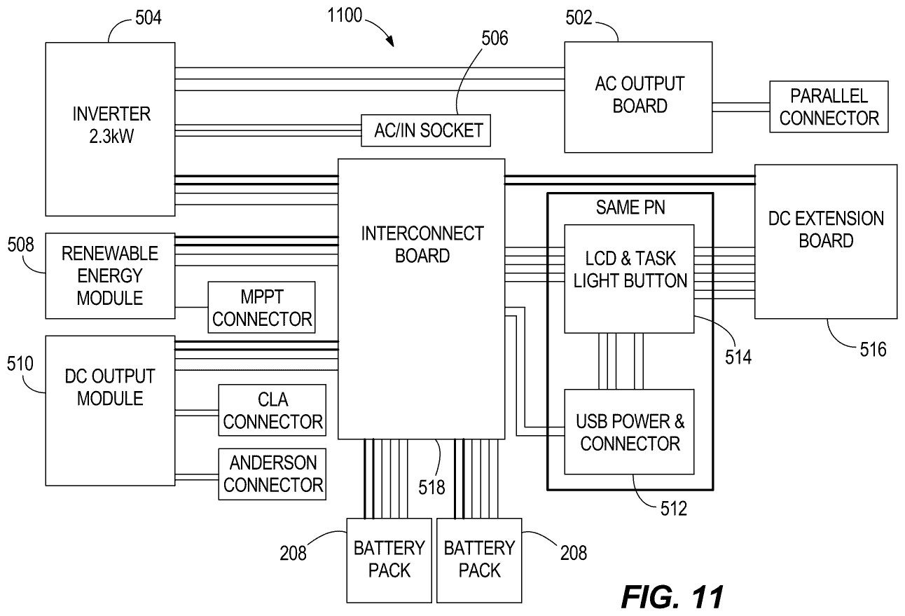

FIG. 6 illustrates a perspective view of an example inverter module 504. The example inverter module 504 includes, among other things, DC input ports 600, AC output ports 602, AC input ports 604, a Type E wire port 606, and a communication wire port 608. The illustrated ports in FIG. 6 are merely examples, and the inverter module 504 may include fewer or more ports than those illustrated. Additionally, in the example of FIGS. 5-6, the inverter module 504 is a 1.8 kW inverter. However, inverters of other types may be used, such as a 2.4 kW inverter or a 3.6 kW inverter (shown in FIGS. 11 and 14-15).

Returning to FIG. 5, the renewable energy module 508 is connected to the interconnect module 518. The renewable energy module 508 is connected to a solar input to receive power from the solar input. The power from the solar input is then provided to other modules via the interconnect module 518.

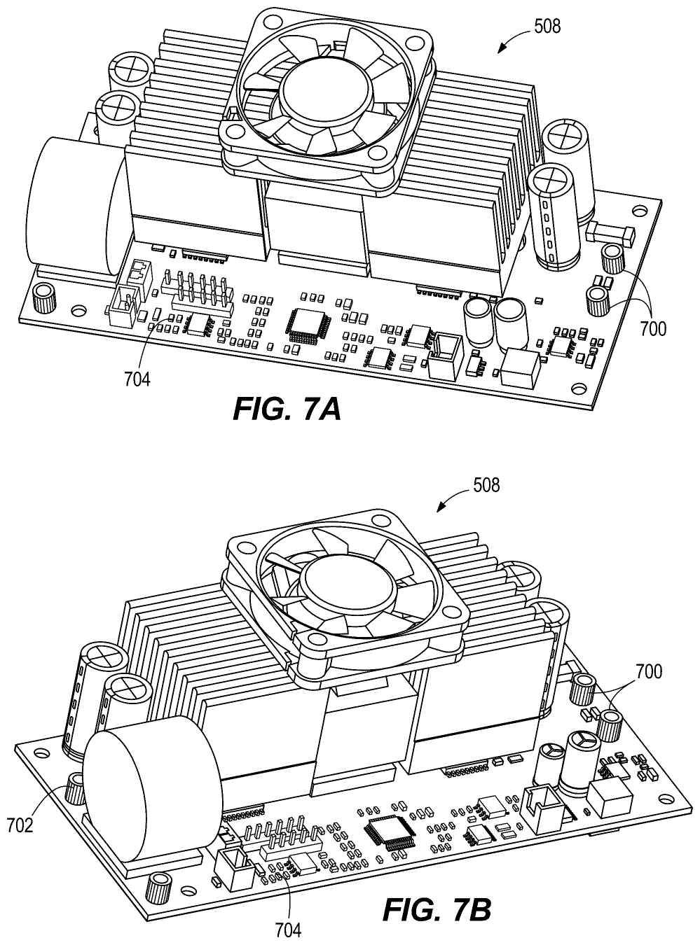

FIGS. 7A-7B illustrate perspective views of an example renewable energy module 508. The renewable energy module 508 includes, among other things, renewable energy input ports 700, a renewable energy output port 702, and a communication wire port 704. The renewable energy input ports 700 are connected to the solar input. The renewable energy output port 702 is connected to the interconnect module 518. The illustrated ports in FIGS. 7A-7B are merely examples, and the inverter module 504 may include fewer or more ports than those illustrated.

Returning to FIG. 5, the DC output module 510 is connected to the interconnect module 518. The DC output module 510 receives DC power from the interconnect module 518 (for example, from the inverter module 504 and/or the battery packs 208) and outputs the DC power via the DC outputs 222 (included in the plurality of power outputs 111).

FIG. 8 illustrates a perspective view of an example DC output module 510. The DC output module 510 includes, among other things, DC output ports 800, a DC input port 802, and a communication wire port 804. The DC input port 802 receives DC power from the interconnect module 518 and provides the DC power via the DC output ports 800. The illustrated ports in FIG. 8 are merely examples, and the DC output module 510 may include fewer or more ports than those illustrated.

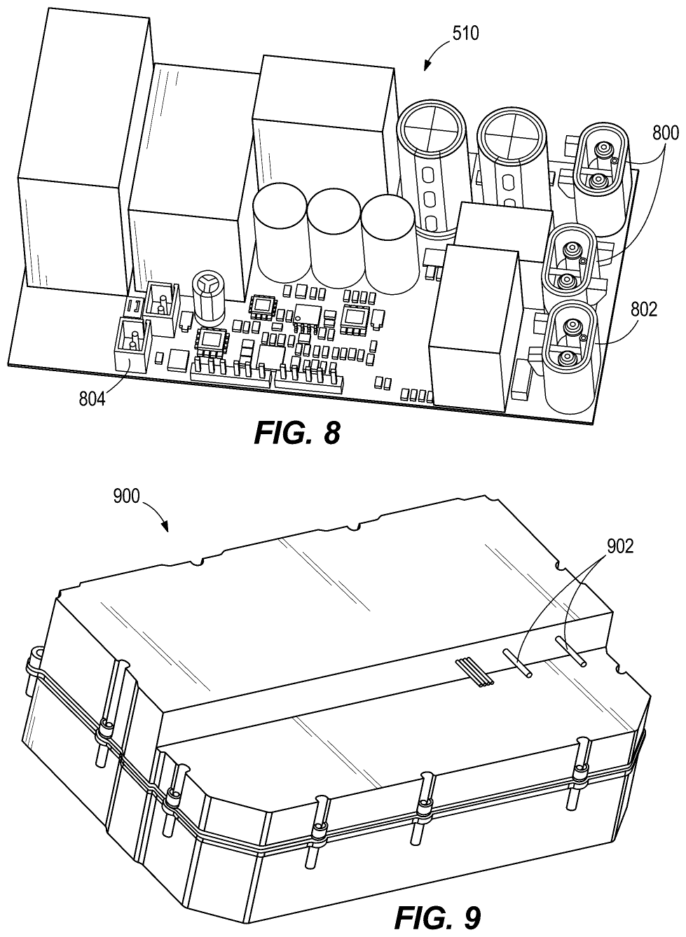

Returning to FIG. 5, battery packs 208 are connected to the interconnect module 518 and may provide DC power to, or receive DC power from, the interconnect module 518. In the example of FIG. 5, the circuit diagram 500 includes only a single battery pack 208. The battery packs 208 may be connected to the interconnect module 518 via a battery module 900, a perspective view of which is illustrated in FIG. 9. The battery module 900 includes DC output ports 902.

The USB module 512 is connected to the interconnect module 518 and to the display module 514. The USB module 512 receives DC power from the interconnect module 518 and provides the DC power to the plurality of USB output ports 112. The display module 514 is connected to the USB module 512 and the interconnect module 518 and provides power to the display 113.

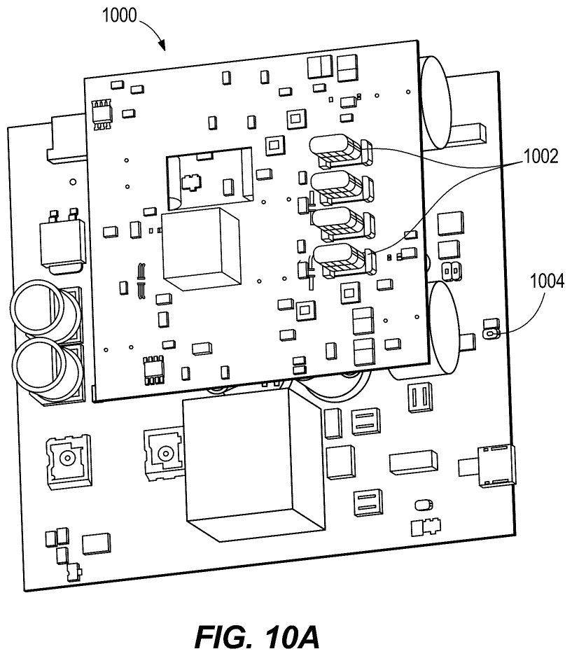

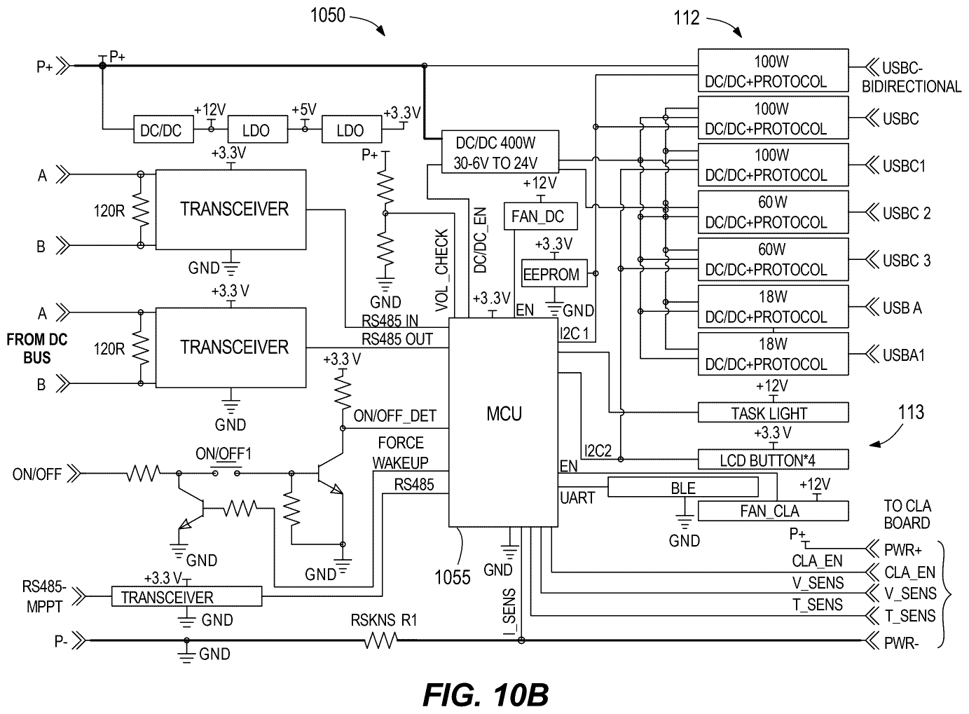

In some implementations, the USB module 512 and the display module 514 are situated on separate PCBs. In other implementations, the USB module 512 and the display module 514 share a single PCB. FIG. 10A illustrates a perspective view of an example PCB 1000 that includes both the USB module 512 and the display module 514. The PCB 1000 includes DC input ports 1002 and a signal input port 1004. The signal input port 1004 may receive commands from the controller 200 related to control of the display 113. The illustrated ports in FIG. 10A are merely examples, and the PCB 1000 may include fewer or more ports than those illustrated. FIG. 10B illustrates a circuit diagram 1050 of the USB module 512 and the display module 514 implemented as a single circuit. The circuit diagram 1050 provides, among other things, the plurality of USB output ports 112 and the display 113. Additionally, the circuit diagram 1050 illustrates a primary controller 1055 that may be included in the display module 514. The primary controller 1055 is connected to each of the other modules and coordinates communication between the other modules.

Returning to FIG. 5, the circuit diagram 500 may include the DC extension module 516. The DC extension module 516 may be connected to the interconnect module 518 and, in some instances, may be connected to the display module 514 for data communication. The DC extension module 516 may connect to a battery extender or other power supply and provide DC power from the battery extender to the interconnect module 518 for use by the other modules.

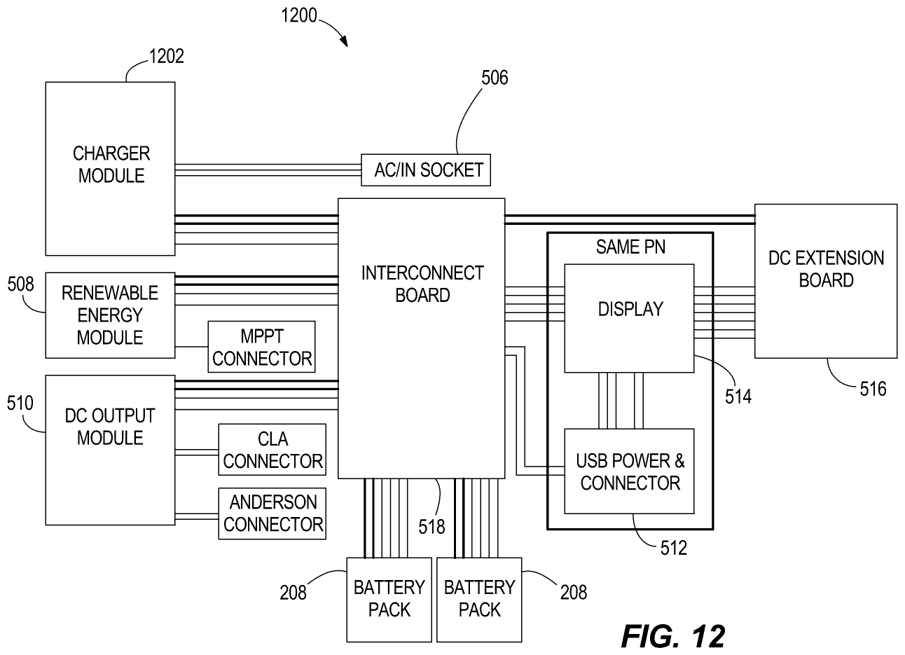

The circuit diagram 500 of FIG. 5 is merely an example. Other modules, electrical components, and configurations thereof may also be implemented with the power station 100, 300. For example, FIG. 11 illustrates an example circuit diagram 1100 including two battery packs 208. As another example, FIG. 12 illustrates an example circuit diagram 1200 that does not include the AC output module 502 or the inverter module 504. Rather, the circuit diagram 1200 includes a charger module 1202 in place of the inverter module 504. The charger module 1202 receives AC power from the AC input 506 and converts the AC power to DC power for use by other modules. For example, the DC power is used to charge the battery packs 208, is output by the DC output module 510, and/or is output by the USB module 512.

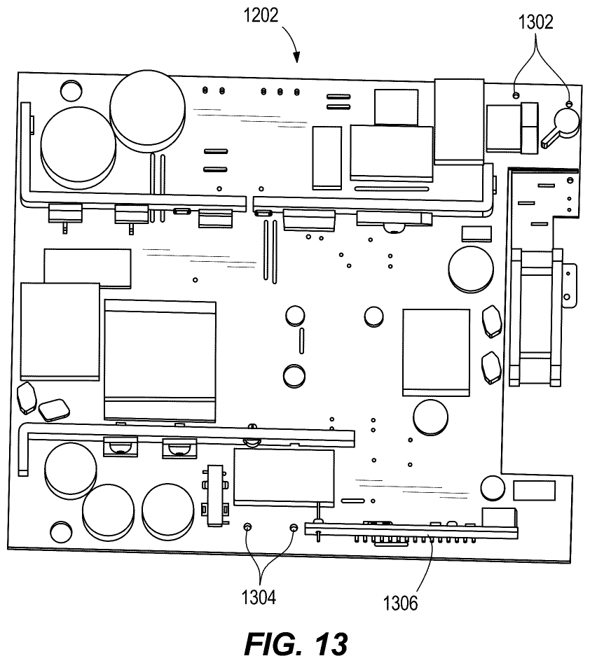

FIG. 13 illustrates a perspective view of an example charger module 1202. The charger module 1202 includes, among other things, AC input ports 1302, DC output ports 1304, and a communication wire port 1306. The charger module 1202 receives AC power from the AC input 506 at the AC input ports 1302 and outputs DC power to other modules (via the interconnect module 518) using the DC output ports 1304. The illustrated ports in FIG. 13 are merely examples, and the charger module 1202 may include fewer or more ports than those illustrated.

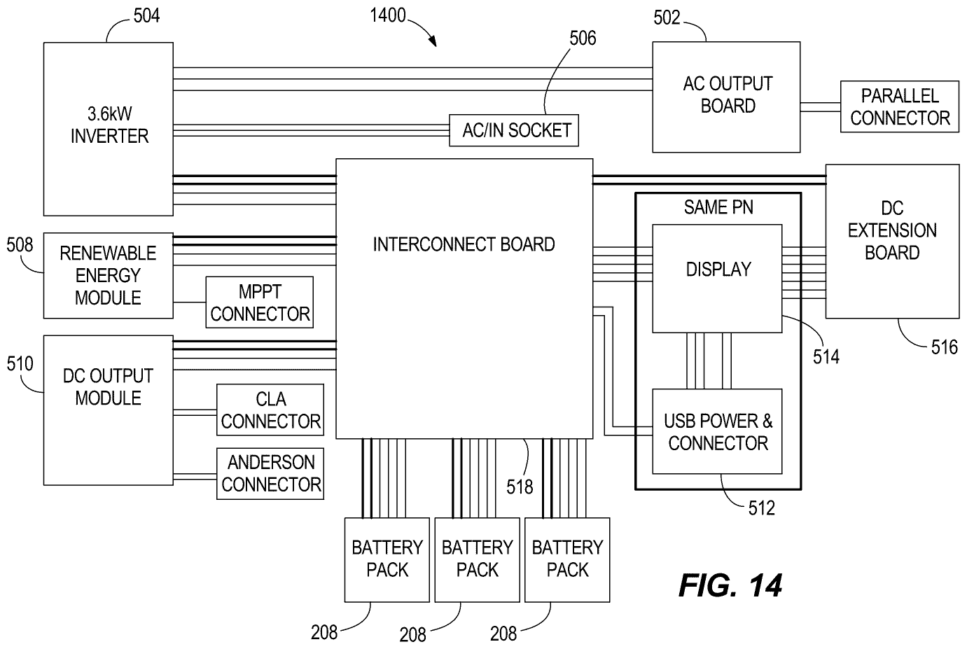

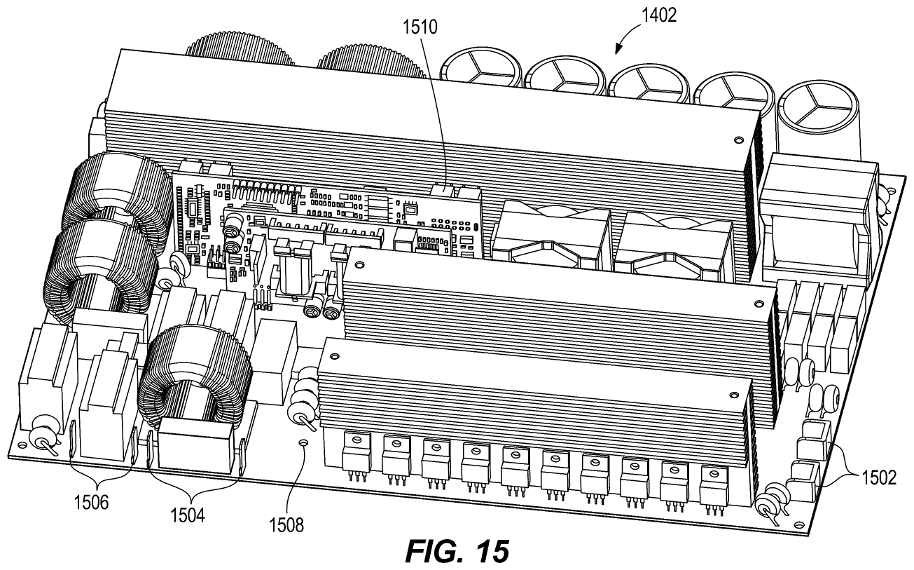

As yet another example, FIG. 14 illustrates an example circuit diagram 1400 that includes a 3.6 kW inverter module 1402 and three battery packs 208. A perspective view of the 3.6 kW inverter module 1402 is illustrated in FIG. 15. The 3.6 kW inverter module includes DC input ports 1502, AC input ports 1504, AC output ports 1506, an E wire port 1508, and a communication wire port 1510. The 3.6 kW inverter module 1402 may operate substantially similarly to the inverter module 504. The illustrated ports in FIG. 15 are merely examples, and the 3.6 kW inverter module 1402 may include fewer or more ports than those illustrated.

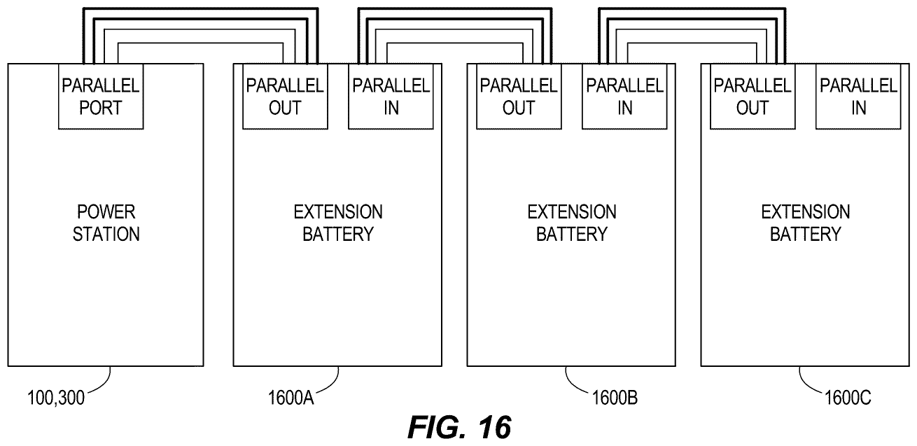

In some instances, the power station 100, 300 may be connected to extension batteries that provide additional power to the power station 100, 300. For example, FIG. 16 illustrates a power station 100, 300 connected in series with a plurality of extension batteries 1600 (e.g., a first extension battery 1600A, a second extension battery 1600B, a third extension battery 1600C).

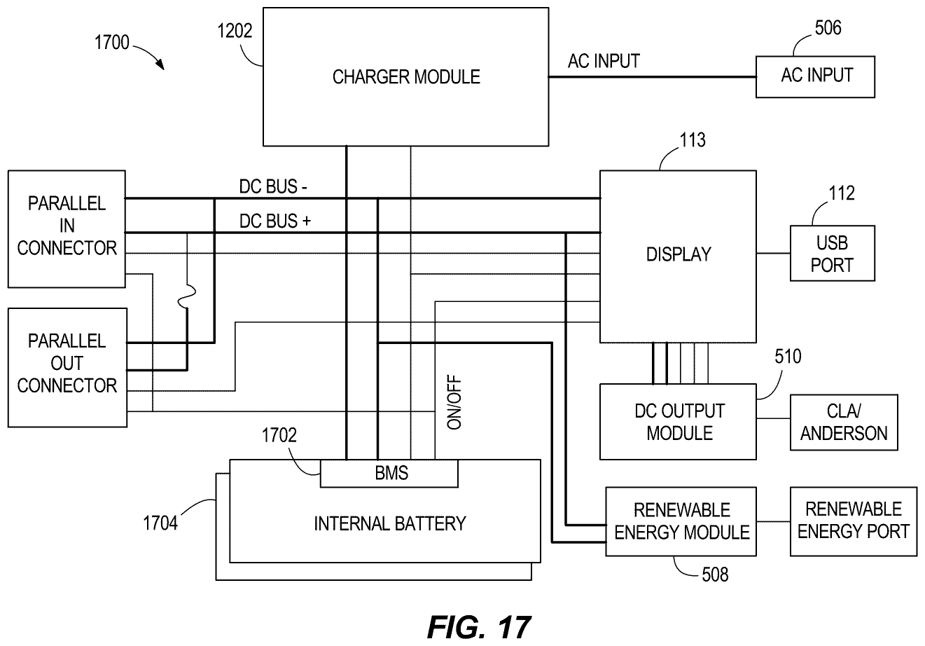

As an example of an extension battery 1600, FIG. 17 illustrates an example circuit diagram 1700 that includes the charger module 1202 that receives AC power from the AC input 506, the display 113, the plurality of USB output ports 112, the DC output module 510, the renewable energy module 508, and a battery management system (BMS) 1702 connected to a plurality of batteries 1704. The charger module 1202 is configured to charge the plurality of batteries 1704 if any charging source is providing power to the charger module 1202. While FIG. 17 illustrates a single BMS 1702, in some instances, each battery 1704 includes its own associated BMS 1702.

The BMS 1702 controls charging and discharging of the plurality of batteries 1704. The BMS 1702 may include several charging and discharging modes. For example, in a “Charge Only Sequence” mode, the BMS 1702 (utilizing the charger module 1202) charges the plurality of batteries 1704 beginning with the battery 1704 having the lowest state of charge. Once the battery 1704 having the lowest state of charge is charged to a constant voltage charge state, the BMS 1702 begins charging the battery 1704 having the next-lowest state of charge. This is repeated until all batteries 1704 have a state of charge at a constant voltage charge state. Once the plurality of batteries 1704 have a state of charge at a constant voltage charge state, the BMS 1702 charges the plurality of batteries 1704 simultaneously using a constant voltage. The BMS 1702 may end the charging operation once any battery 1704 is fully charged.

In a “Discharge Only Sequence” mode, the BMS 1702 discharges the plurality of batteries 1704 beginning with the highest voltage battery 1704 and ending with the lowest voltage battery 1704. For example, consider a situation where the plurality of batteries 1704 includes a first battery, a second battery, and a third battery. The second battery has the highest voltage, the first battery has the lowest voltage, and the third battery has a voltage between the second battery and the first battery. The BMS 1702 first discharges the second battery until the voltage of the second battery is approximately equal to the voltage of the third battery. The BMS 1702 then discharges the second battery and the third battery together once their voltage difference is within a threshold (e.g., 2 V). Next, the BMS 1702 discharges the first battery, the second battery, and the third battery together when each of the batteries are within the threshold. Once the batteries are each discharged, the BMS 1702 controls a charging FET to charge the batteries.

In a “Charge While Discharge Sequence” mode, the BMS 1702 reduces the requested charging current such that the charge current is within a required limit. For example, the BMS 1702 may cut the charging current in half compared to the “Charge Only Sequence” mode. If input power is removed, the BMS 1702 may immediately discontinue charging of the plurality of batteries 1704. If input power is provided, the BMS 1702 may immediately re-initializing charging of the plurality of batteries 1704. During each charging and discharging mode, a status of the charging or discharging may be provided via the display 113.

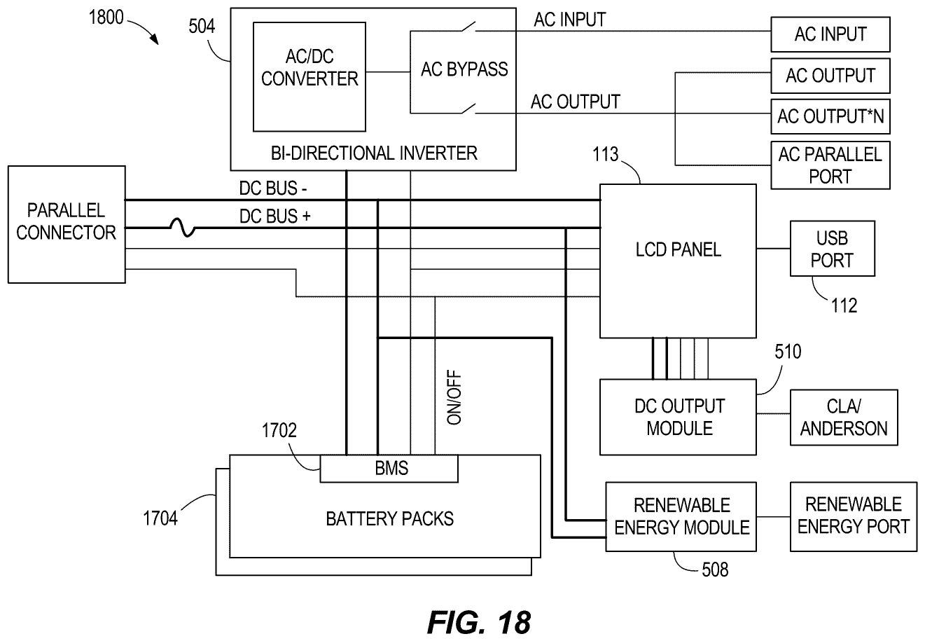

The power station 100, 300 may also implement the BMS 1702, as shown in circuit diagram 1800 of FIG. 18. The BMS 1702 may control charging and discharging of the one or more battery packs 208 in a similar manner as described with respect to the plurality of batteries 1704 in FIG. 17.

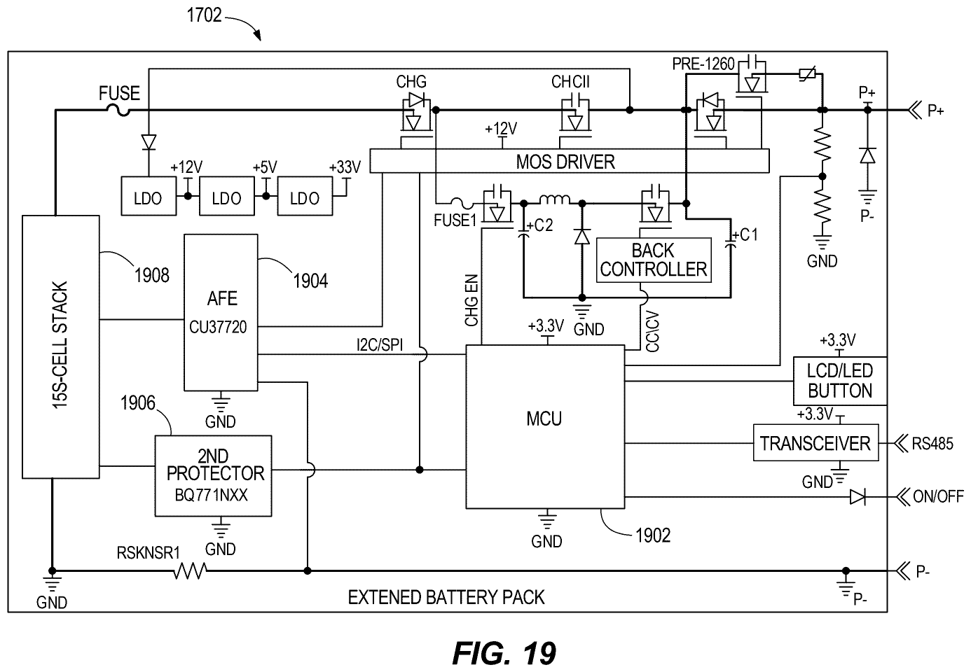

FIG. 19 illustrates a circuit diagram of an example BMS 1702 implemented in an extended battery 1600. The BMS 1702 includes a battery controller 1902, an Analog Front End (AFE) circuit 1904, a secondary protection circuit 1906, and a plurality of battery cells 1908. The battery controller 1902 may control charge and discharge operations of the plurality of battery cells 1908. The AFE circuit 1904 is a dedicated controller that controls analog aspects of battery management, such as cell voltage monitoring, cell balancing, current monitoring, coulomb counting, and protection control. The secondary protection circuit 1906 operates as a back-up protection circuit in case the AFE circuit 1904 or the battery controller 1902 fails.

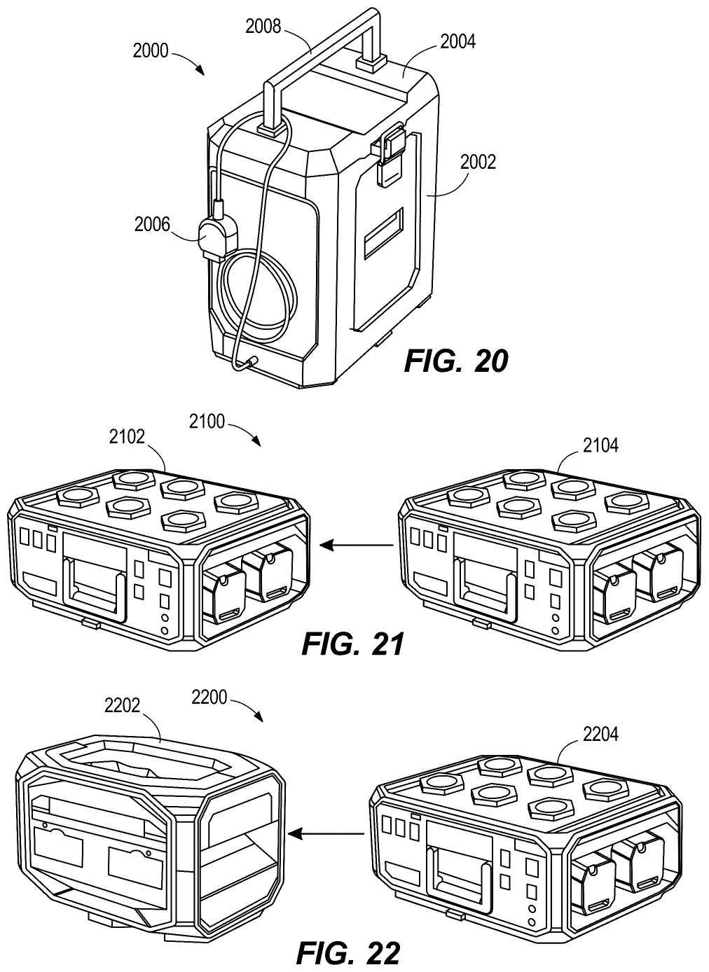

FIG. 20 illustrates an example battery extender 2000. In some embodiments, the battery extender 2000 includes an extender housing 2002, a cover 2004, a connecting cable 2006, and a handle 2008. The cover 2004 may be removably coupled to the extender housing 2002. When the cover 2004 is removed, a battery pack interface (not shown) may be accessed by a user of the battery extender 2000. The battery pack interface may be configured to receive one or more battery packs such that the battery packs are supported within the extender housing 2002. In another implementation, the battery extender 2000 may include one or more internal, non-removable batteries. The battery extender 2000 is configured to output power from the battery packs or the internal batteries via the connecting cable 2006 to another connected device, such as a power station 100, 300. The connecting cable 2006 may or may not be capable of being unplugged from the battery extender 2000.

Accordingly, examples described herein provide for various power stations 100, 300 that include different batteries, housing, and circuitry. Each power station 100, 300 includes a DC extension module 516 that provides for one power station 100, 300 to another power station 100, 300. For example, FIG. 21 illustrates a power supply system 2100. The power supply system 2100 includes a first power station 2102 electrically connected to a second power station 2104. In the example of FIG. 21, both the first power station 2102 and the second power station 2104 are configured to receive battery packs. The second power station 2104 is configured to receive power from the first power station 2102. In some implementations, the first power station 2102 merely acts as a power supply for the second power station 2104. Accordingly, the second power station 2104 may control all charge and discharge operations of received battery packs and may control output of power by the plurality of power inputs 110, the plurality of power outputs 111, and the plurality of USB output ports 112.

As another example, FIG. 22 illustrates a power supply system 2200. The power supply system 2200 includes a first power station 2202 electrically connected to a second power station 2204 in parallel using the AC inputs/outputs. In the example of FIG. 22, the first power station 2202 includes one or more internal, non-removable batteries and the second power station 2204 is configured to receive battery packs. The first power station 2202 is configured to receive power from the second power station 2204. In some implementations, the second power station 2204 merely acts as a power supply for the first power station 2202. Accordingly, the first power station 2202 may control all charge and discharge operations of internal batteries and may control output of power by the plurality of power inputs 110, the plurality of power outputs 111, and the plurality of USB output ports 112. In other examples, the second power station 2204 may be configured to receive power from the first power station 2202.

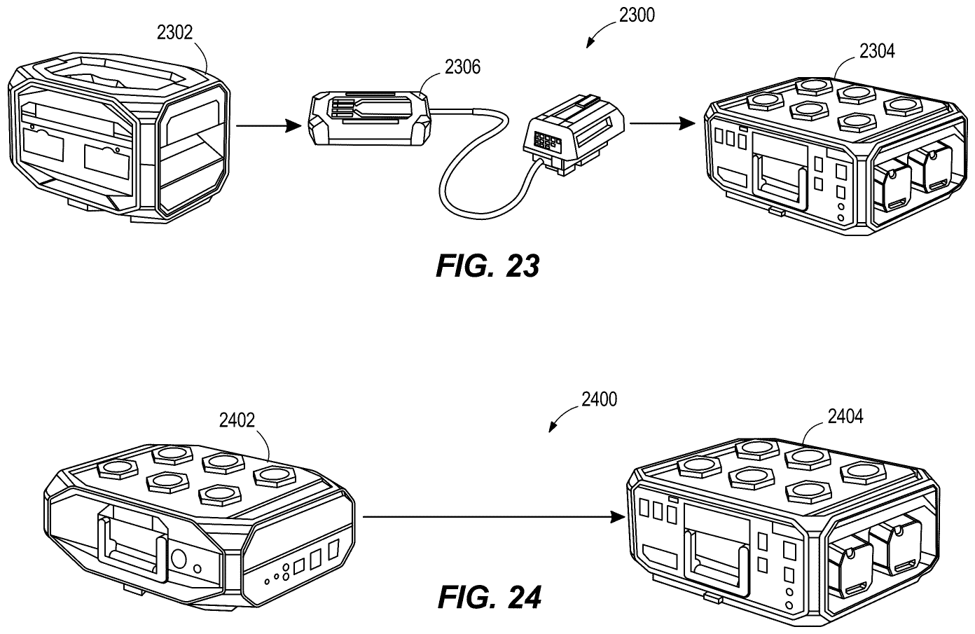

In some instances, a power converter may be connected between two power stations or between power stations and battery extenders. For example, FIG. 23 illustrates a power supply system 2300. The power supply system 2300 includes a first power station 2302 electrically connected to a second power station 2304 via a power converter 2306 (e.g., a DC/DC converter). The first power station 2302 is configured to provide power to the second power station 2304. The power converter 2306 may be configured to convert a voltage output by the first power station 2302 to a voltage that is usable by the second power station 2304.

As another example, FIG. 24 illustrates a power supply system 2400. The power supply system 2400 includes a battery extender 2402 electrically connected to a power station 2404. The battery extender 2402 is configured to provide power to the power station 2404 and acts as an additional power source for the power station 2404 (for example, in addition to received battery packs or internal batteries). In the example of FIG. 20, the battery extender 2402 includes one or more internal, non-removable batteries.

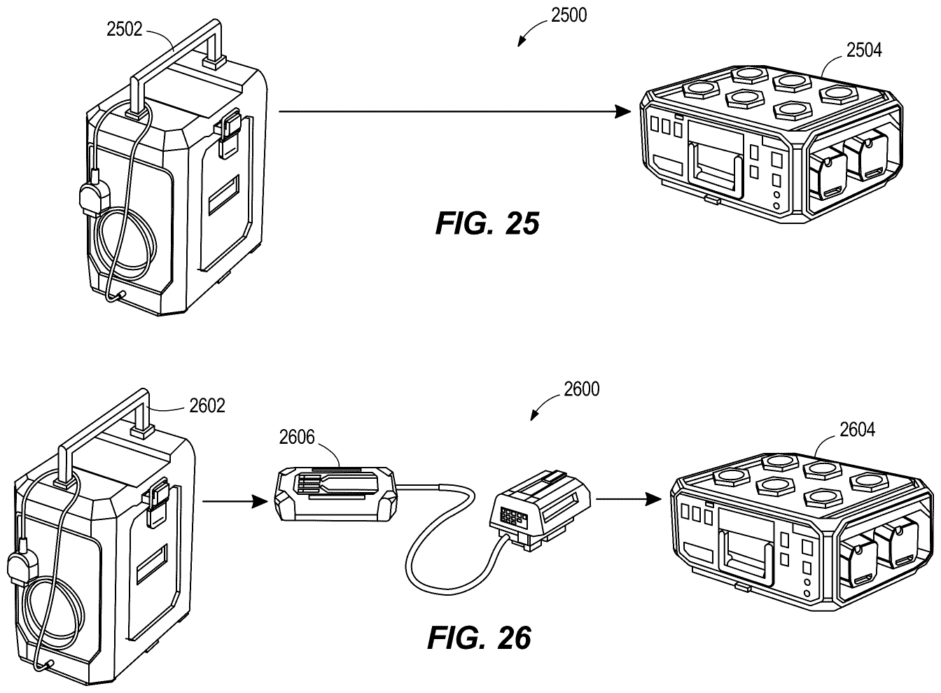

As another example, FIG. 25 illustrates a power supply system 2100. The power supply system 2500 includes a battery extender 2502 electrically connected to a power station 2504. The battery extender 2502 is configured to provide power to the power station 2504 and acts as an additional power source for the power station 2504 (for example, in addition to received battery packs or internal batteries). In the example of FIG. 25, the battery extender 2502 includes one or more battery packs received by a battery pack interface of the battery extender 2502. Although the illustrated examples of FIGS. 24 and 25 provide a battery extender 2402, 2502 connected to a power station 2404, 2504 that is configured to receive battery packs, in other instances the battery extender 2402, 2502 may also be connected to a power station 2404, 2504 that includes internal batteries.

As yet another example, FIG. 26 illustrates a power supply system 2600. The power supply system 2600 includes a battery extender 2602 electrically connected to a power station 2604 via a power converter 2606 (e.g., a DC/DC converter). The battery extender 2602 is configured to provide power to the power station 2604. The power converter 2606 may be configured to convert a voltage output by the battery extender 2602 to a voltage that is usable by the power station 2604.

In some examples, by connecting power stations, battery extenders, and/or rapid charging accessories, any one power station may receive power from anywhere between one and twelve battery packs. In some examples, connected power stations, battery extenders, and/or rapid charging accessories are connected in parallel. In other examples, connected power stations, battery extenders, and/or rapid charging accessories are connected in series.

Additionally, embodiments described herein provide for both simultaneously charging received battery packs or internal batteries while also providing power to connected devices without interruption in power supply operation.

Thus, embodiments described herein provide, among other things, power stations, battery extenders, and configurations for connecting the same. Various features and advantages are set forth in the following claims.

What is claimed is:

1. A power supply system comprising:
a battery extender configured to output a first direct current (DC) power; and
a power station electrically connected to the battery extender, the power station including:
a battery,
a DC input port configured to receive the first DC power from the battery extender,
an alternating current (AC) input port configured to receive first AC power from an external power supply,
a DC output ports configured to provide a second DC power to a first connected device, and
an AC output ports configured to provide second an AC power to a second connected device.

2. The power supply system of claim 1, wherein the battery extender includes a non-removable battery within a housing of the battery extender.

3. The power supply system of claim 1, wherein the battery extender includes a battery pack interface configured to removably receive a battery pack.

4. The power supply system of claim 1, wherein the battery is a non-removable battery within a housing of the power station.

5. The power supply system of claim 1, wherein the battery is a battery pack removably connected to the power station.

6. The power supply system of claim 1, wherein the power station further includes a solar panel configured to generate a third DC power.

7. The power supply system of claim 1, wherein the power station further includes a station housing having an upper portion, wherein the upper portion includes a contour extending from the upper portion, wherein the battery extender includes an extender housing having a lower portion, wherein the lower portion includes a recess configured to receive the contour.

8. The power supply system of claim 1, further including a charging accessory connected between the battery extender and the power station, wherein the charging accessory supplements the first DC power provided by the battery extender to the power station.

9. The power supply system of claim 1, wherein the power station further includes a display situated on a housing of the power station, wherein the display is configured to display information related to the battery.

10. The power supply system of claim 1, wherein the power station further includes a wireless charging station configured to provide power wirelessly to a device situated approximate to the wireless charging station.

11. The power supply system of claim 10, wherein the power station further includes a station housing having an upper portion, wherein the wireless charging station is embedded within the upper portion.

12. The power supply system of claim 1, wherein the power station further includes a controller configured to control a flow of power from the DC input port and the AC input port to the DC output port and the AC output port, and wherein the controller is configured to control a flow of power from and to the battery.

13. The power supply system of claim 12, wherein, when the first connected device is connected to a first DC output port, the controller is configured to prioritize the flow of power to the first DC output port, and provide remaining input power from the DC input port and the AC input port to the battery.

14. The power supply system of claim 1, wherein power from the DC input port, the AC input port, and the battery is combined and provided to at least one selected from a group consisting of the first connected device and the second connected device.

15. The power supply system of claim 1, wherein the power station further includes an inverter module converted to convert power received from the DC input port and the AC input port.

16. The power supply system of claim 1, further comprising a DC/DC power converter electrically connected between the battery extender and the power station.

17. A power station comprising:
a plurality of batteries;
a direct-current (DC) input port configured to receive a DC power from an external battery extender;
an alternating current (AC) input port configured to receive a first AC power from an external power supply;
a DC output port configured to provide a second DC power to a first connected device;
an AC output port configured to provide a second AC power to a second connected device; and
a battery management system configured to charge the plurality of batteries in response to receiving power from at least one selected a group consisting of the DC input port and the AC input port.

18. The power station of claim 17, wherein, when in a first charging mode, the battery management system is configured to:
charge a first battery of the plurality of batteries having a lowest state of charge; and
charge, in response to the first battery being charged to a constant voltage charge state, a second battery of the plurality of batteries.

19. The power station of claim 17, wherein, when in a first discharging mode, the battery management system is configured to:
discharge a first battery of the plurality of batteries having a highest voltage; and
discharge, in response to the voltage of the first battery being equal to a voltage of a second battery, both the first battery and the second battery.

20. The power station of claim 17, wherein the plurality of batteries are non-removeable batteries within a housing of the power station.
